(19) United States
(12) Patent Application Publication
(10) Pub. No.: US 2002/0133456 A1
(43) Pub. Date: Sep. 19, 2002

(54) Systems and methods for using derivative financial products in capacity-driven industries

(76) Inventors: John M. Lancaster, Copperhill, TN (US); Deborah Lancaster, Copperhill, TN (US)

Correspondence Address: LONG ALDRIDGE & NORMAN LLP, 701 Pennsylvania Avenue, N.W., Suite 600, Washington, DC, 20004, US

(21) Appl. No.: 10/006,654

(22) Filed: Dec. 10, 2001

Related U.S. Application Data
(60) Provisional application No. 60/254,734, filed on Dec. 11, 2000.

(51) Int. Cl. G06F 17/60

(52) U.S. Cl. 705/37; 705/5

(57) ABSTRACT

In capacity driven industries, traditionally negotiated distribution and marketing agreements are used to buy and sell traditional units of capacity, for example, airline seats. Derivative products are used to buy, sell and trade standardized units of capacity in an over the counter (OTC) market and/or open derivative market. The derivative products are based on underlying features of a particular capacity driven industry to be traded as options, e.g., puts and calls, forwards, futures, swaps, or swaptions. The derivative products are based on verifiable financial evaluation of the standardized units and fair market value of the units available for purchase for each derivative product. These derivatives enable suppliers to monetize embedded derivatives within long-standing distribution practices.

This application claims the benefit of U.S. Provisional Patent Application No. 60/254,734, filed on Dec. 11, 2001, which is hereby incorporated by reference for all purposes as if fully set forth herein.

### BACKGROUND OF THE INVENTION

1. Field of the Invention

The present invention relates to systems and methods for utilizing options in capacity-driven industries.

2. Discussion of the Related Art

The Internet is a global network of connected computer networks. Over the last several years, the Internet has grown in significant measure. A large number of computers on the Internet provide information in various forms. Anyone with a computer connected to the Internet can potentially tap into this vast pool of information.

The most wide spread method of providing information over the Internet is via the World Wide Web (the Web). The Web consists of a subset of the computers connected to the Internet; the computers in this subset run Hypertext Transfer Protocol (HTTP) servers (Web servers). The information available via the Internet also encompasses information available via other types of information servers such as GOPHER and FTP.

Information on the Internet can be accessed through the use of a Uniform Resource Locator (URL). A URL uniquely specifies the location of a particular piece of information on the Internet. A URL will typically be composed of several components. The first component typically designates the protocol by with the address piece of information is accessed (e.g., HTTP, GOPHER, etc.). This first component is separated from the remainder of the URL by a colon (‘:’). The remainder of the URL will depend upon the protocol component. Typically, the remainder designates a computer on the Internet by name, or by IP number, as well as a more specific designation of the location of the resource on the designated computer. For instance, a typical URL for an HTTP resource might be:

http://www. server.com/dir1/dir2/resource.htm

where http is the protocol, www.server.com is the designated computer and /dir1/dir2/resouce.htm designates the location of the resource on the designated computer.

Web servers host information in the form of Web pages; collectively the server and the information hosted are referred to as a Web site. A significant number of Web pages are encoded using the Hypertext Markup Language (HTML) although other encodings using the extensible Markup Language (XML) or the Standard Generic Markup Language (SGML) are becoming increasingly more common. The published specifications for these languages are incorporated by reference herein. Web pages in these formatting languages may include links to other Web pages on the same Web site or another. As will be known to those skilled in the art, Web pages may be generated dynamically by a server by integrating a variety of elements into a formatted page prior to transmission to a Web client. Web servers and information servers of other types await requests for the information that they receive from Internet clients.

Client software has evolved that allows users of computers connected to the Internet to access this information. Advanced clients such as Netscape's Navigator and Microsoft's Internet Explorer allow users to access software provided via a variety of information servers in a unified client environment. Typically, such client software is referred to as browser software.

The Internet provides a global vehicle for communicating information and for creating electronic marketplaces. Electronic commerce sites have been established in any number of diverse industries. The Internet has made major in-roads into supporting commercial activity of capacity-driven industries such as airlines.

The foregoing trends and background provide detailed information surrounding the current state and needs of the airline industry. However, similar situations exist in other capacity-driven industries such as air cargo, oil pipelining, advertising and telecommunications. The foregoing, therefore, should be taken as exemplary of a capacity- driven industry situation and in no way limits the scope and use of the present invention to the airline industry.

The worldwide air travel market worth exceeds $1 trillion annually. The U.S. travel industry is a $386 billion USD annually industry. The European and Asian markets are of comparable size.

Currently, 80% of all travel products are sold through 30,000 retail travel agencies and scores of consolidators. Direct sales by asset suppliers account for only 20% of total sales. Today, Internet sales comprise 2% of the direct sales, but are expected to rapidly increase in importance over the new few years. The size of the travel business-to-business (B2B) marketplace is very large. Revenues from leisure and corporate travel earned by U.S. travel agencies exceed $50 billion USD annually.

Within the $50 billion USD annual agency sales number, there are airline products sold through a series of negotiated agreements. Historically, these agreements are made with discounters, wholesalers, and consolidators—all long-standing members of the travel distribution network. Consolidators contract with suppliers to secure inventory at discounted (wholesale) prices, or purchase the inventory directly. They then resell the inventory at prices higher that their cost, yet below published retail prices, generating a profit on the spread. Airlines use negotiated agreements to target specialized or desired market segments that they wish to reach. In the lightly regulated U.S. domestic air travel industry, approximately 20%-30% of all sales flow through negotiated agreements. Europeans move 50%-60% of their volume through “net fare” programs. Asian private channel distribution exceeds 90%.

Airline also use a closely related set of contractual arrangements to create interline marketing relationships. These agreements are called code-share agreements. Under a code-share, an airline agrees to allow another airline to market either all seats or a block of seats on selected flights. These agreements take four forms: hard block, soft block, sell and report, and Available Seat Mile (ASM) buys.

Recent U.S. government reports project a doubling of U.S. domestic air travel in the next decade. U.S. carriers are flying full, yet yields are falling and revenue growth is slower than expected. Coupled with this explosive growth, is the rapid evolution of Internet sales channels in the air travel industry. A Morgan Stanley Dean Witter (MSDW) report predicts that by 2002 the online sale of air travel products will exceed the sale of all other products online, perhaps excluding pornography. Travel suppliers, in large part, support this migration, as the resulting distribution cost savings can be immense. Increasingly, airlines are using their Internet sites to market their products and are selling distressed inventory through online auction sites.

Public acceptance of the Internet sales channel has been enthusiastic. The flying public has jumped onto the new channel. They are enjoying the new ease of finding low-cost travel alternatives, comparison-shopping, and gathering more information to guide their decisions. In short, they see and understand the versatile increases in the information that is just a click away. Unfortunately for the airlines, a symmetric increase in information has not yet materialized. This asymmetric informational growth is altering the balance of power in the industry.

As travelers seek to extract and organize availability and pricing information, new and unique travel business models are proliferating. As a result, each new Internet start-up is seeking special fares or negotiated programs—initiating their reach to more than just the traditional ‘wholesalers’. This has increased the demands on the airlines to negotiate more agreements, under more uncertain market conditions and with less information. Given the potential reach of an Internet company, a poorly organized negotiated agreement can have drastic effects. Airlines and other travel suppliers are recognizing the importance of managing negotiated programs to protect yields and grow incremental revenue. Unfortunately, the structure and management of negotiated programs has never been efficient and is not easily adaptable to the new “e-realities”.

Now add to this mix the emergence of powerful online B2B marketplaces in the travel industry. MSDW reports that the greatest impact yet to the electronic distribution of travel products will come from the birth of these B2B marketplaces. As of Fall 2000, a B2B open exchange (Excambria.com), a massive consolidator fare posting site (Patheo.com), and a site that lists consolidator prices and business practices (ConsolidatorProfile.com) have been launched. More launches are expected. Established players, such as SABRE, have recently taken action that clearly indicates they also intend to enter the B2B cyberspace. These sites assist intermediaries in conducting their business more efficiently, by replacing their existing phone and fax systems. The new online marketplaces will globalize the consolidator distribution potential, expanding their reach beyond personal relationships and localized knowledge of supply and demand. True B2B e-commerce allows any legitimate business the opportunity to secure travel inventory for resale, opening the possibility of travel product speculation.

While online B2B marketplaces are designed to facilitate consolidator and distributor businesses, they provide solutions for travel supplier challenges. An open and neutral exchange serves both suppliers' and distributors' needs. It creates a two-way flow of demand, price and elasticity of information. An exchange also fosters the emergence of a secondary market. This secondary market offers increased profit opportunity to suppliers, as well as distributors. Significant challenges do exist. Answers to commoditization and further erosion of fares and yields have to be found before suppliers can responsibly participate. To participate and realize the true potential of exchanges, travel suppliers will have to learn how to manage their price risk.

To date, an adequate travel supplier response to these new realities has yet to be shaped. But, consolidators are flocking to these exchanges to offer their negotiated supply for sell. Travel suppliers are only beginning to become aware of these B2B marketplaces. They have not yet grasped their potential power. Understandably, airlines and other suppliers are concerned about the introduction and growth of these marketplaces. They threaten ‘click and mortar’ e-commerce strategies, allow the emergence of powerful new navigators/market makers, and dilute their revenues via price transparency. Moreover, the exchange creates a marketplace where consolidators can take full advantage of the financial power conferred by their individual negotiated programs. In the new B2B exchange, negotiated and code sharing agreements can be structured as financial instruments and sold.

Currently, the travel supply chain is being deconstructed. Suppliers have to respond to these new trends. Furthermore, the antiquated and broken processes of negotiated programs will certainly not help suppliers deal with this new reality.

Negotiated programs are not effective business models. For example, negotiated programs experience spoilage problems. Consolidators receive a fare level, an inventory class, and quite often a block of seats on a given flight that they can use at their discretion. Often, this process results in spoilage of the supplier's inventory. This occurs when the blocked seats are returned to the inventory too late in the booking curve to sell to other potential customers. Thus, the flight departs with empty seats or seats must be sold at a discount. This situation is especially true of soft-block and hard-block code share agreements. The current airline-consolidator and airline-airline relationship leaves no mechanism for dividing the financial risk of spoilage between the two parties. Why should airlines continue to shoulder all this risk, while consolidators receive the benefit of their discounted fares? Is this economically sound or efficient?

Moreover, negotiated agreements are susceptible to dilution. Most negotiated agreements between airlines and consolidators specify static fare levels, called private or net fares. Static fares are not responsive to the dynamic nature of demand and prices. As customers show they are willing to pay more for a given day/time departure, the private fare does not alter. Thus, the consolidator undercuts (dilutes) what the airline could have received for the seat, and retains all the upside for himself.

Airlines attempt to mitigate the ill effects of consolidator and code-share agreements by regulating the acceptance of their bookings, via their revenue management systems. To do this requires that consolidator and code-share bookings be identified and classified as such a low yield booking. Unfortunately, it is often the case that the agreements are structured in a way that hides these bookings, e.g. requiring premium fare classes be assigned. When this happens low yield consolidators or code-share bookings are classed (“bucketed”) with high yield fare products. Consequently, the bookings are accepted rather than rejected in favor of higher yield bookings.

A partial answer to this situation is to negotiate discounts from the lowest available booking fare. This means the consolidator's fare level floats with respect to other demand. Unfortunately, this style of negotiated program is the perfect arbitrage instrument in the presence of an Internet marketplace. Now the consolidator can display and sell discounted fares with the reach and power of the Internet. They can directly compete with the airline and Internet providers with their own customer-facing sites (e.g., e-bookers.com).

Another consolidator alternative would be to sell discount fares, en masse, to other distributors at a B2B marketplace (e.g., Excambria.com). In either case, the airlines have no protection from the risk of dilution as these private fares reach more passenger segments (even the coveted business traveler) and prove difficult to track. Should airlines be providing consolidators with such powerful, dilutionary agreements without compensation?

The same is true of code-share agreements.

Ideally, all negotiated programs would reflect one business model. This would make management of the programs easier and more predictable. A single fare level or series of fare levels could be produced and distributed. Historically, negotiated programs have never been this way.

The competitive pressures of each consolidator's niche market preclude the use of a single business model. Any one means of computing fares and commissions would be less than optimal. So, specialization of agreements becomes a requirement. To handle this, airlines maintain expensive sales and pricing departments to negotiate contracts. They employ staff to administer and monitor the agreements and deploy complex accounting software to compute revenues and commissions. The specialization of contracts greatly increases the workload for airlines and consolidators, often for an unknown benefit.

The emerging B2B world finally allows airlines to introduce a standardized agreement structure where prices respond dynamically to market conditions. The result is a drastic streamline in airline work processes. Given these benefits, why should there not be a single, dynamic business model governing the relationship of airlines and distributors in the new economy?

Traditional airline pricing and revenue management techniques are antiquated in view of the current economy. Traditional revenue management functions according to the theory that the controlling price determines airline revenues. Balancing the demand for discount fares against the revenue potential of high yield late bookers requires coordinated control of fares, which are available and known to the public, at any point in the booking process. To serve this need, airlines have relied upon privately owned Global Distribution Systems (GDS) and proprietary networks. These have a highly specialized query language, which serves to limit, coordinate, and control availability and pricing information. Revenue management works because the public has always had a channeled view of alternatives and prices. Historically, consolidator net fares fit this system. They have targeted and limited reach, which made them not easily accessible to the general public.

The publicly owned Internet, which is already widely used for distributing availability and pricing information, threatens to alter radically this situation. When net fare information is readily available to consumers and businesses, how are airlines going to force the public to work within their Computer Reservation Systems (CRS) regulated, information restricted environment? Given the continually escalating costs in the CRS arena, do they even want to?

Currently, published airline fares are not set according to any systematic evaluation formula. Airlines set their published fares for competitive positioning. The situation with private fares is worse. Private fares are oftentimes a seat of the pants ‘guesstimate’—or worse, a competitive response to another carrier's ‘guesstimate’. Nowhere is the invisible hand of supply and demand, or the customer's willingness to pay, directly considered.

As a result, often there are 100% load factor flights in markets where people are willing to pay 2-3 times the published fares, but no seats are available. A prime example is the San Francisco to Hong Kong first class round trip market. Travelers in this market are price insensitive. This market flies full capacity every day at $4,000 a seat, and is booked solid months in advanced. There are executives, who must fly on short notice in this market, unable to find a seat even when they are willing to offer $10,000 plus for a seat. Published fare ladders make it impossible to respond. Even if a seat becomes available, the airline would sell it for $4,000—losing $6,000 of potential upside! That equals capturing 10 discount coach customers. Yet, competitive pressures make it too risky for any single airline to announce a significantly higher fare in the SFO-HKK market.

Consider another example: United Airlines' Summer 2000 of Hell. Faced with pilot troubles, UAL lost traffic to other competitors because their inflexible fare structure could not respond, losing millions of dollars a day. Creative, market-driven pricing could have responded to these operational and market issues. If the marketplace had determined fare levels, UAL could have still flown full. However, it would have been discounted to reflect the public's evaluation of how much their inconvenience was worth. As a result, overall revenues would most likely have been higher than reported along with some positive customer perception that UAL was ‘doing something’ about the customer's resulting inconvenience.

Airline pricing and revenue management are inflexible vestiges of airline fare pseudo-regulation and information restriction. They are incapable of being adapted to respond in a vibrant web-based, market-driven economy. In the new B2B marketplace, fares dynamically adjust to market pressures, creating unlimited upside potential in high demand and limited fare drops in low demand. How can a rational, profit-oriented airline pass up this opportunity?

When the airline industry was tightly regulated, all carriers serving a market offered identical published fares, fixed by government oversight. This was a good deal for the airlines. The bulk of the public could be counted on to deliver a quality government- mandated yield. To get that strategic edge and fill empty seats, airlines created negotiated programs for niche consolidators. They offered bulk rates to large business or convention groups, special discount agreements to corporate accounts, and cruise/tour package operators off the board.

These discounted fares made sense. They were targeted, limited in scope, and slipped around the government regulations. The extra sales from these programs formed an airline's competitive edge. For this reason, control resided in the sales department, which seeks to boost sales, not necessarily yield. As a result, negotiated programs have not evolved or adapted to the virtual fare regulation resulting from the Internet marketplace. As a consequence, revenue management departments never effectively controlled negotiated, block space or code-share programs. The uniqueness of each market and consolidator deal makes forecasting and management difficult. As a result, airlines manage blocks, groups, and negotiated fares manually. Channel controls have only begun to be explored in airline circles. In the totally unregulated, no-holds-barred world of the Internet, how will this dated paradigm fare?

Deconstruction of the travel industry supply chain requires new business methods. In the years since deregulation, airlines have maintained their ability to control the prices made known to the general public. Use of the proprietary GDS/CRS networks enabled airlines to pseudo-regulate the travel industry. Hierarchical control of distribution information extends down into the relationships dictated by negotiated agreements. Airline affiliation is maintained via the arcane commission structure and rewards of highly profitable peak-season traffic.

The single strongest message from e-commerce is that success follows customer affiliation, not supplier affiliation. Thus, it follows that this pseudo-regulation of fares must change or be eliminated. Survival pressures in travel e-commerce are shifting consolidator affiliation away from an airline-centric focus. The opening of consolidator based B2B marketplaces accelerates this trend. The collapse of airline pricing control has already happened and cannot be reversed. The electronic equivalents of People's Express, virtual discount airlines will follow ‘virtual deregulation’ as surely as the original discount airlines followed the Carter administration's deregulation. Moreover, an electronic B2B marketplace invites the creation of travel product speculators.

The natural first reaction of travel suppliers has been attempts at constructing Internet channels in which the suppliers hold equity. Using the power of their equity, suppliers seek to maintain the affiliation of their preferred Internet channels. Furthermore, they hope to restrict the growth of other web-based channels that they do not sponsor.

The travel agency community, seeking to expand its own Internet presence, has sounded an alarm. Concerns over selective distribution and special fare generation have prompted legal objection to the Orbitz web site. A government investigation has been launched.

Each new Internet business model asks travel suppliers for private fares and special modifications to the consolidator model. Airlines and other suppliers are being overwhelmed by the increased workload. Just trying to sort through the proposals is straining the limits of their staff. Yet, decisions are needed more quickly.

On top of this, the future viability of most Internet players is questionable. Picking the right Internet distributor early can be hugely profitable. Coming on board after the site is established could be costly. So it is dangerous to ignore a new request for distribution deals. This places even more dependence on a highly qualified, savvy staff. So workload mounts, compensation fails to keep pace, and the Internet companies poach the highly qualified staff.

It is a world where the speed of information and change demand automation and standard processes to deal with the great bulk of situations. In the airline industry, the need for standardization of negotiated programs is greater than ever. It allows suppliers to respond quickly and effectively to new possibilities. It would make sense to design and manage a standard negotiated agreement based on the economic nature of the agreement.

Suppliers need more than revenue management. Revenue management seeks to maximize revenue at the point of consumption. The ‘right price at the right time to the right customer’ philosophy is the right answer for a pseudo-regulated world without price transparency or risk. As long as pseudo-regulation and limited access continue, traditional revenue management and negotiated programs meet the needs of travel suppliers.

The open markets of the Internet are radically different. In the demand driven market, with dynamic pricing, the risk/reward calculus becomes paramount. Rapid dissemination of pricing and availability information, open trading of net/private fares and commoditization make price risk a major consideration. Revenue management has no models to meet the demands of large-scale channel control. Suppliers seek a better answer that manages risk and revenue simultaneously.

Airlines and travel suppliers could simply continue with business as usual. They could manage negotiated programs in the traditional method. In a maelstrom of change, this would be an ill-fated strategy to pursue. This strategy does not address the dilution that occurs from negotiated agreements in an exchange-enabled world.

Suppliers are exposed to price risk from fierce pricing competition. The Internet intensifies that exposure. Often they do not recognize the price risk because inflexible pricing systems mask market adjustments as demand drops. This leads airline managers to assume they face a business risk rather than a market risk, thus hiding the price risk. Hidden risk increases the cost of doing business. Controlling price risk needs to become a major component of airline thinking.

The airline's price risk is clearly seen in a negotiated program. Consolidators using a negotiated program are free to find business wherever they can. The exchange offers them the opportunity to sell inventory to Internet distributors or speculators at near net fare levels. Now, those distributors turn around and sell that inventory on the net, below the airline's published fares. The airline is forced either to lower published fares or eliminate the negotiated program. The airline is injured by this consolidator arbitrage.

Failure to adapt to this arbitrage undercuts revenues. By failing to capitalize on the economics of an exchange, suppliers suffer downward pressure on prices. At the same time, the workload and cost continue to spiral upward. By using the leverage of economic efficiency, suppliers can reap additional revenues from negotiated programs.

Finally, the overall goal of the supplier is to remain competitive. The supplier that adopts a better solution to handle and manage these programs creates uneven returns. The Internet escalates the reward of a competitive edge. Being first matters.

A few airlines and travel suppliers are taking the approach that says ‘that which I cannot control, I will simply choose not to participate.’ This seems like a do-able solution until one considers the complexity created by the advent of the Internet. First of all, airlines and travel suppliers would need to find out where is the abuse. Where are these exchanges and de facto secondary markets being created? Airlines and travel suppliers need to find out who is participating in these exchanges, and the detail of what transactions are taking place within the exchange. A newly created exchange (Excambia.com) has stated that the identity of two parties who commence a transaction on its exchange will never be known. So, policing the situation is not going to be easy or cheap.

Today, there are measures in place that provide some degree of comfort to the travel suppliers and airlines that special fares are not being abused; for example, tracking special fare accessibility and usage to an ARC or IATA number. In the future, agencies will put in subsystems to track sales and payments amongst themselves. Trading, arbitrage and speculation are profitable when pursued on an Internet scale.

It may seem that shutting down negotiated programs to draconian and controllable levels will prevent this; it is a false hope. If formal trading channels are shut down, distributors will launch bots to create a black market. Discount inventory will be scraped up by pirate-bots straight out of the reservation system and resold. Antiquated CRS/GDS technology is vulnerable to bot and web technologies. It makes the potential returns on bot-piracy enormous.

Airlines and travel suppliers must remember the overall goal of pricing is to stay competitive. Competitors cannot afford to be ‘out of line’ with market pricing.

Moreover, negotiated programs do offer value. They only need to be structured to insure a profitable airline. Destruction of negotiated programs is akin to throwing the baby out with the bath water.

If there is a profitable line of business, agents and consolidators will find a way to make that line of business work. If trading in a secondary market makes money, or if the sale of net fares is advantageous, it will happen formally or informally, just as it does on a small scale today, particularly, as the airlines alienate the travel agent community by pushing commission down to ever-lower levels. Good business requires cooperative relationships, not antagonistic ones.

In another potential approach, a travel supplier could simply decide to deal with the changing world around them by staffing up their pricing, sales, and revenue management departments to handle the increased negotiated program workload. However, such approach puts more strain on an existing system and infrastructure that is questionable at best. Without being able to quantify the benefit, increased staffing cannot be justified. The impact of micro managing negotiated programs is unknown.

Several of the major U.S. air carriers are taking the exclusivity approach. They hope to win back control from travel agencies and consolidators by circumventing them and the GDSs. They are building their own direct Internet channels and airline owned Internet companies (e.g. Orbitz.com, HotWire.com). This strategy is appealing but has a serious flaw.

These sites lack customer affiliation. Internet navigators build their success on the customer perception of neutrality or customer affiliation. Price conscious consumers will never trust these sites to navigate them to the lowest fare. At a minimum, neutrality is important. This defeats the purpose of supplier-affiliated sites.

The bottom line is, airlines are not Internet companies. Airlines are already seeing their private brand websites being used “to game the system.” The time, talent, effort and funding required to build Internet distribution channels tax the most technologically fluent companies. This approach is beyond the abilities of all but the largest airlines. Even for the majors, their administrative slowness and low pay scales may be fatal.

This approach also misses the potential benefits of inventory hedging. Until airlines begin to partner with their distributors on equal terms, they will continue to shoulder the entire risk burden of inventory ownership. The revenue enhancement created by the greater economic efficiency cannot be realized unless the airlines choose to participate intelligently in the new supply chain.

The answer to the problem facing suppliers in capacity-driven industries is the financial derivative products according to the present invention.

### SUMMARY OF THE INVENTION

Accordingly, the present invention is directed to systems and methods for utilizing derivative instruments in capacity-driven industries that substantially obviates one or more of the problems due to limitations and disadvantages of the related art.

An advantage of the present invention to enhance revenue in capacity driven industries by providing a secondary market for a unit of capacity.

Another advantage of the present invention is to provide the ability to value the financial worth of a negotiated agreement or code-share agreement.

Another advantage of the present invention is to utilize the practice of hedging to reduce risk exposure by restructuring cash flow.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method of trading an airline fare product includes providing a derivative product wherein the derivative product is based on a forward contract for the purchase of at least one airline fare product; and at least one of selling, trading, and executing the derivative product.

In another aspect of the present invention, a method of trading derivative products related to airline fare products includes transforming negotiated airline fare agreements between parties comprising suppliers and distributors into derivative products; and at least one of selling, trading, and executing the derivative products.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram of a typical system according to the present invention;

FIG. 2 is a graphical depiction of utilization of the present invention where the provider serves the role of an investment bank; and

FIG. 3 is a graphical depiction of utilization of the present invention where the provider serves the role of a market maker.

### DETAILED DESCRIPTION OF THE ILLUSTRATED EMBODIMENTS

Reference will now be made in detail to an embodiment of the present invention, example of which is illustrated in the accompanying drawings.

A Capacity Based Product is a sellable product based on the ability to transport items from one geographic location to another. These items may be physical or informational.

A Commodity is a standardized product that can be bought or sold.

A Call Option is an agreement, which gives the holder the right to buy the underlying asset by a certain date for a certain price.

A Derivative Product is a contract defining a contingent claim agreement between two or more parties based on the behavior of a specified unit with verifiable financial worth. These products include options, swaps, exchanges and other similar financial instruments.

A Derivative Security is a financial security whose value depends on the values of other more basic underlying securities.

An Exchange Functionality Provider is an organization that runs a trading exchange

An Exotic Derivative is a derivative product with exotic features.

A Forward Contract is an agreement to buy or sell an asset at a certain future time for a certain price. These contracts are usually made between two parties and are not normally traded in an exchange.

A Future is a contract for the purchase and delivery of a commodity at some forward (future) date.

A Knock-Out Barrier is an exotic feature in which the derivative's value goes to zero if the price of the commodity reaches an agreed upon level during the life of the derivative.

Negotiated Agreements are contracts used to establish negotiated programs.

Negotiated Programs are agreements between a travel supplier, and a distributor. This agreement specifies how the distributor may sell the travel product. This includes how he will be paid; the way the travel product is sold; prices, discounts, or commissions; and defines what is sold through inventory and non-inventory actions.

An Option is a contractual agreement between two parties specifying rights, obligations, conditions, and pay-off structure for the purchase and sell of a commodity over a specified period of time.

An Options Functionality Provider is an organization that issues and financially backs option products.

An Options Market is a market for trading options.

A Path-Dependent Feature is a feature of an option that affects the pay-off function based on the trajectory of the underlier's value.

Price Volatility is a statistical measure of the size of the change in price of a commodity at it's next instantaneous trade.

A Put Option is an agreement that gives the holder the right to sell the underlying asset by a certain date for a certain price.

A Security is something given as a pledge of repayment.

Spoilage is excess capacity above the purchased demand that goes unused at the time of transport.

Strike Price is an agreed-upon purchase price, which will be paid at a future purchase time.

Tickets are forward contracts for delivery of travel commodity services.

Travel Booking/Reservation is an agreement between travel product supplier and the customer to sell a ticket at a certain price for a fixed length of time.

A Travel Commodity is space rental for a particular time on a vehicle moving from Point A to Point B, and all the services required to ensure that.

Travel Commodity Booking is a call option contract between travel supplier and buyer for the purchase of a forward contract on a travel commodity. This contract specifies the price and date of agreement expiration.

A Travel Consolidator is an organization between the travel supplier and the front line distribution. Travel consolidators negotiate large blocks of tickets or fares with a supplier, and then sell in small lots to individual distributors or agencies.

A Travel Distributor is, for example, a travel agent or online distributor.

Travel Suppliers are organizations that provide and sell travel commodities. Examples are airlines, passenger trains, cruise lines, hotels, and resorts

Virtual Inventory is inventory that is electronically controlled and traded, but not owned.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

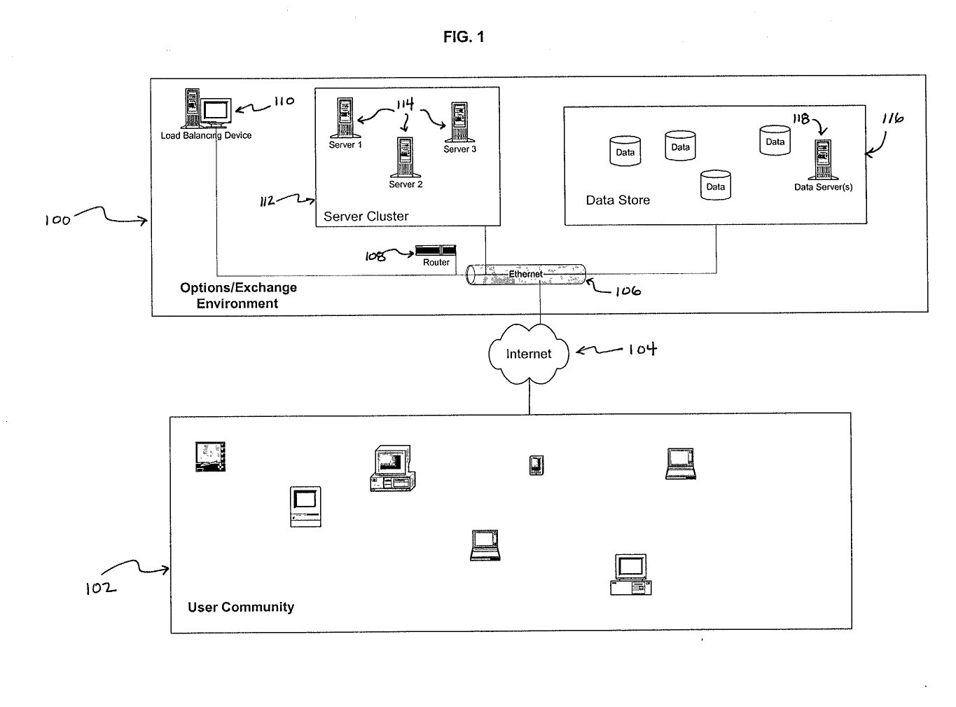

FIG. 1 provides a diagram of the architecture of the typical derivatives and/or exchange environment 100 according to the present invention. In embodiments utilizing both an exchange and derivatives environment, the same hardware may be used to provide the entire functionality. In other embodiments, the functionality may be split across separate hardware elements that may or may not be provided by a single source. In such embodiments, the options functionality provider may have an architecture according to FIG. 1, and the exchange functionality provider may also have a separate architecture according to FIG. 1.

As seen in FIG. 1, members of the user community 102 such as suppliers, consolidators and distributors access the desired functionality via user terminals. The user terminal may be a computer, a telephone, a personal data assistant device (PDA) or other suitable device for data entry and interaction. The user terminals are connected to the environment via a communications channel such as a computer network, a dial-up connection, a standard land or mobile phone or radio connection or other suitable communications mechanism. Multiple communication channels may be available in certain embodiments. In one such embodiment, the user terminal connects to the environment via the Internet 104 as depicted in FIG. 1. In another embodiment, a land or telephone connection may be used in connection with an automated voice response system integrated into the environment (not shown).

The derivatives/exchange environment 100 according to the present invention may, in one embodiment, utilize a single computer utilizing local data storage with one or more suitable connections to the communication channel(s) utilized by the user terminals. The various elements of the environment in this embodiment could communicate through a local bus connection. Other embodiments may scale to include more complicated arrangement of processing, storage and communication elements.

One such embodiment is depicted graphically in FIG. 1. The elements of the environment communicate through a computer network such as an Ethernet 106. The Ethernet 106 as depicted utilizes a router 108 to properly direct communications among the elements of the environment. The environment may include a load balancing device 110 to distribute work appropriately among the various elements of the environment.

Environment processing may be centralized in a server cluster 112 including one or more server systems 114. Server systems 114 may provide a variety of functionality. This functionality may include Internet server functionality for fielding requests from appropriate Internet clients and application servers. Examples of such Internet servers include Web servers for fielding requests from Web browsers, FTP servers for fielding requests from appropriate clients, SMTP servers for fielding e-mail services and other commonly accepted servers. In many instances, Web browsers include appropriate software hooks to act as clients to other types of Internet servers rather than limited to interacting with Web servers. Application servers provide local processing to generate dynamic information through the application of appropriate business logic to data retrieved from the data store and/or supplied by the Internet servers from the members of the user community or other sources. In some embodiments, the application servers may also support interfacing between the Internet servers and the data store.

Storage capability of the environment may be centralized in a data store 116. The data store may include a variety of heterogeneous elements. The elements may include network connect storage devices and/or database servers 118. In embodiments utilizing database servers 118, the data store may include one or more database server systems 118 allowing access to data distributed across one or more storage devices. The database servers may utilize any suitable architectural framework such as relational, object-oriented, hierarchical, spatial or a hybrid architecture such as object-relational.

The present invention provides financial engineering technology to enable the creation of financial derivative products such as options for the capacity-driven industries such as travel. This technology may be marketed to the suppliers and may be used to assist them in turning negotiated and code-sharing agreements into financial derivative products. The technology may also include, in certain embodiments, the communication layer between the supplier and the exchange that lists the derivative product for sale. In one model the communication may be conducted for a standard commission fee.

The present invention creates risk management and investment strategies and supports trading inventory and derivative products using traditional distribution systems or one or more of the emerging exchanges. In this regard, the provider of technology according to the present invention acts as the ‘investment bank’ on behalf of the supplier such as airlines. This provider, in one embodiment, may provide access to the technology at no direct charge to clients by retaining a percentage commission on trades by clients.

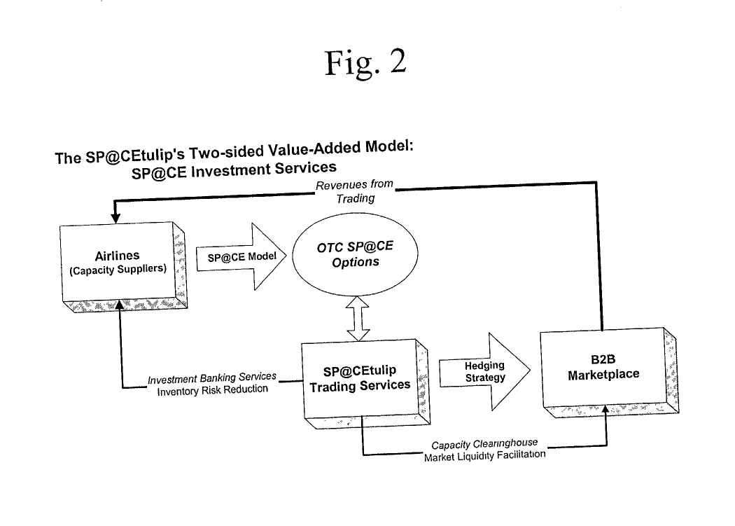

FIG. 2 provides a graphical depiction of this embodiment. A capacity supplier, who creates distribution agreements, chooses to redefine their agreements to honor the financial value of the agreement. For clarity, the airline example shall be explained in detail to illustrate FIG. 2. While different capacity-based distribution industries may use different names and variants of the distribution agreements described here, the system and process principles described can be equally well applied to those other industries.

In the airline industry, business-to-business (B2B) distribution agreements are called negotiated agreements. Standard negotiated agreements come in three basic forms: commission/discount based agreements, net (private) fare agreements, and block space agreements. The features of these three types of agreements have to do with the nature of fare agreements, availability guarantees and manner of incentive pay to the distributor. The basic features of each type of agreement are outlined in the following table.

TABLE 1
Features of Airline Negotiated Agreements

| | Commission/Discount | Net Fare | Block Space |
|---|---|---|---|
| | Agreements | Agreements | Agreements |
| Fixed Fare | No, sell GDS available | Yes | Yes |
| | fare | | |
| Availability | Based on Inventory | Based on Inventory | Guaranteed |
| | Controls | Controls | |
| Commission/ | Yes | Sometimes | No |
| Incentive | | | |
| Volume | Yes | Yes | No |
| Discount | | | |
| Purchasing | No | Yes | Yes |
| Time Limit | | | |
| Inventory | Yes | Yes | No |
| Control | | | |

The particularities of individual industries present many challenges to the standard Black-Scholes option-pricing model. In the airline industry, option-pricing model accommodates the features of airline capacity and inventory control: 1) perishability at departure, 2) price volatility, 3) fare restrictions, 4) the risk of non-liquidity, 5) knockout barriers, and 6) other features. Using solid financial engineering techniques, any feature of a negotiated and code-sharing agreement that is desired by a supplier can be priced. This aspect may be present at either the supplier side or incorporated into an online exchange.

In the airline industry these negotiated and code-sharing agreements are fundamentally forward contracts for the purchase of airline fare products. These agreements structure the distribution relationship between an airline and the consolidators, corporate sales agencies and wholesalers entitled to distribute to specialized markets. Increasingly, Internet distribution sites are falling into the negotiated arena as the practice of equity-ownership for participation becomes less used.

According to the present invention, these negotiated agreements are converted from forward contracts to exotic derivative products. Currently, airline product distribution relies on fixed relationships and a controlled business-to-business (B2B) marketplace. Retaining the economic value of the forward contract is considered of little importance. Airline control of who sells what product, how and to whom prevents serious revenue dilution. The idea underlying derivatives-based distribution is encapsulating the economic value of the distribution relationship in a derivative product, to provide dilution protection as control of the distribution chain is lost.

Inventory hedging begins by realizing that the future price is the sum of the current price and value of future price movements. These future price movements are uncertain and represent risk to the holder of inventory. Everyone selling inventory must decide whether to sell now or continue holding, risking immediate profit for the possibility of a better deal to come. Rationally, this decision is based on whether the expected value of future price movements meets expectation. An option prices that expected value. This allows a supplier to hedge its inventory successfully. The process builds option-based hedging strategies. Options, tied to the spot market price, provide the means of proportionally and manageably sharing risk between suppliers and distributors. It ties the distributors' interest to the interest of the supplier through risk and profit sharing. Inventory hedging offers the strategic potential, flexibility, and the leverage of financial risk management to answer the challenges of distribution across the electronic supply chain.

The economic benefits of derivatives in the commodity's supply chain are felt by each of us everyday. Derivatives smooth out the effects of uncertain harvests and the fluctuations in jet fuel prices. The expansion of the U.S. agribusiness since 1850 has largely been economically fueled by the growth of future and option markets in agricultural products. Fuel hedging has become a staple for controlling airline costs. The present invention brings those same benefits to travel product markets. Hedging programs according to the present invention mitigate much of the supplier's risk of entry into an exchange. By stimulating the use of B2B product exchanges, the present invention offers a three-sided value proposition to suppliers, distributors, and exchanges. This contributes to increasing the economic efficiency of the marketplace. Suppliers benefit from the two-way flow of information that is engendered by using an exchange. A standardized, dynamic pricing methodology allows the market to be responsive to public demand and ends the appearance of price collusion. Inventory hedging is a sound business practice that can immediately be reflected in the stock evaluation of the hedger. Distributors can use derivatives to secure inventory, provide fixed procurement costs, and/or speculate on demand. Risk management according to the present invention aid buyers, sellers, speculators, and hedgers utilize the emerging exchanges. This builds transaction volume and market liquidity thus providing a more stable, secure product supply chain.

The present invention improves the statistical use of pricing and demand information via the enriched two-way flow of information in new B2B e-marketplaces. Leveraging existing legacy systems, the present invention can be integrated into the current workflow of suppliers and distributors with the least impact possible.

The option transformation of FIG. 2 entails creating exotic call derivatives to replace the individually negotiated agreements used now. The mapping of negotiated agreements to exotic derivative features allows a practitioner to use published pricing models to price agreements and sell them to distributors. This reduces the inherent risk of currently practiced negotiated and code-share agreements. The following tabulation of exotic call option features illustrates how many of the distribution features desired by airlines can be meet by derivatives-based distribution.

TABLE 2
Exotic Derivative Features Used to Characterize Negotiated Agreements

| | Commission/Discount | Net Fare | Block Space |
|---|---|---|---|
| | Agreements | Agreements | Agreements |
| Fixed Fare | Variable Strike Price on | Fixed Strike Price on | Fixed Strike Price on |
| | Call Option | Call Option | Call Option |
| Availability | Variable Strike Price | Knock-out Barrier | Contractually |
| | | | Assured |
| Commission/ | Strike Price as a | Strike Price as a | Fixed Strike Price |
| Incentive | Discount Factor | Discount Factor | |
| Volume | Lot Discount on Full | Lot Discount on Full | Do not Discount Lots |
| Discount | Option Lots | Option Lots | |
| Purchasing | Expiration Date = | Expiration Date Prior | Expiration Date Prior |
| Time Limit | Departure Date | to Departure Date | to Departure Date |
| Inventory | Tie Strike Price | Ascending Series of | Contractually |
| Control | Calculation to | Strike Prices and | Assured Protection |
| | Controlled Fare | Knock-out Barriers | of Availability |

The option transformation is performed and facilitated by an investment services provider. This investments service provider issues the option product, takes the opposite side of the sold contract, guarantees the contract, and in turns sells complimentary agreements to distributors in the business-to-business marketplace. Alternatively, the airline could use the investment services provider to broker a derivatives-based distribution agreement between them and a distributor.

Derivative-based distribution is the idea that the electronic distribution of travel services and/or rentals is based on a network of rights. The basic right is the customer's ability to reserve a service of particular quality, at a particular time. In general, that is done through intermediaries. Other rights include availability guarantees, pricing agreements, commissions and discounts, reservation time limits, ability to resell (distribution rights), bundling rights and other aspects of channel control. Each of the features of the distribution arrangement awards rights to one party and obligations to the other party. Rights and obligations have financial consequences on the business of each party.

A right gives one party the freedom and flexibility to receive a service that they can dependably consume in their own business activities. The security of being able to acquire the service makes the later business activity achievable as needed. This has financial value and should be purchased.

An obligation restricts the business possibilities of the obliged service provider. The restrictions curtail the profit potential of the service provider. The provider should seek to receive fair compensation for the loss of potential.

An example that illustrates this principle is the issuing of block space agreements in the air travel industry. A block space agreement is a distribution agreement in general made between a cruise line and an airline. The agreement facilitates the air transportation of cruise passengers to their port of departure in a package deal for the cruise. In this type of agreement, the airline party to the agreement agrees to provide a block of seats to the cruise line at a fixed (usually discounted) fare. These seats are guaranteed to be available to the cruise line up to an agreed upon time prior to the flight departure. This is done though a separate inventory mechanism in the airline's computer reservation system, called block space records. The cruise line can then bundle the air transportation into a package without the risk of fluctuating air transportation costs. The transfer of the reservation rights of the airline inventory to the cruise line makes the selling of cruise packages financially feasible and allows the cruise line to generate profit from the package. Thus the right has financial value to the cruise line. Correspondingly, the airline has accepted the obligation of providing the reservation at a fixed price to the cruise line. The airline has incurred a lost opportunity cost, because it can speculatively withhold the reservation to seek a better price later in the booking period.

The buying of rights and selling of obligations is the essence of derivative contracts. Derivative-based distribution redefines the current network of distribution agreements in terms of the exchange of rights and obligations between parties involved in the distribution and delivery of a service. It classifies these rights and obligations exchanges in contracts; which can then be sold, traded and executed by parties in the distribution chain. The restructuring of the distribution chain improves efficiency throughout the industry as risks of doing business are spread fairly across all participating players. Those garnering the benefits of distribution rights pay for the privilege and those accepting the obligations are compensated accordingly.

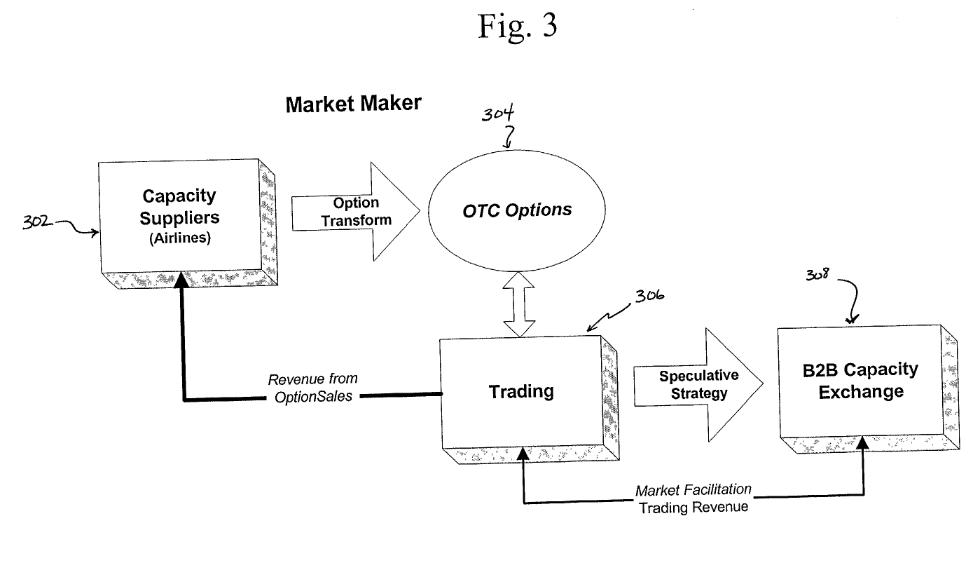

In a further embodiment, the provider of technology according to the present invention may serve as a ‘market maker’ for the derivative products in an exchange environment. In one such embodiment, the provider may cover all costs to participate and trade, keeping all resulting upside/downside revenues. FIG. 3 provides a graphical depiction of this embodiment. As in FIG. 2, the following explanation is given in terms of the airline industry. The system and process principles are applicable to a variety of industries.

In this embodiment, an active trading member of a business-to-business exchange playing the role of market maker decides to use derivative products to facilitate his/her trading activities. The market maker approaches an airline supplier 302 to establish a distributor relationship. The market maker proposes the creation of an over-the-counter derivative 304. It is envisioned that the market maker would be willing to propose calls and puts to the supplier 302. The market maker would back each of the supplier-facing derivatives to procure “virtual inventory” that can be used to support trading activities 306. The derivative product would be designed from the same set of features described in TABLE 2: path-dependent features, variable strike price formulae, and basket features.

The market maker, described in FIG. 3, would then trade inventory and distributor-facing derivatives in an exchange 308. This role would very similar to the bond houses trading treasury bonds. By directly securing distribution rights from suppliers, the market maker forms the first tier of trading in the exchange. The ability to back derivative products would open up the market maker's ability to establish futures and derivatives markets.

In the realization of one embodiment, the environment owner acts as the issuer of capacity-based futures and options for capacity commodities or capacity futures. The environment owner would be able to address the needs of a community of capacity buyers by being able to issue, price and sell financial instruments, encapsulate the rights and obligations to sell and purchase capacity-based services.

For example, if a party approaches the issuer to sell them the right to purchase, at any point over the next two months, a fixed amount of transportation capacity to be used three months in the future, then the said issuer could write a contract fairly laying out the terms of such an agreement, price the contract, guarantee delivery on the execution of the contract and sell the contract to the interested party. Here the approaching party wishes to purchase a right from the issuer, having the issuer take on the obligations of the contract. This is a call option on the underlying transportation capacity.

Another example arises when a party approaches the issuer to purchase from them the right to sell a fixed amount of capacity for use three months in the future on a fixed date two months away. This is a put option on the underlying capacity. The approaching party wishes to take on the contract obligation for the immediate cash earned in selling the right to the issuer.

Inherent in this role is the notion backing the option. By taking the opposite side of each contract, the issuer facilitates the continued commercial activity of the market. It assumes and manages the risk associated with the agreements. The issuer would be capable of assessing the financial risks of distributing capacity-based commodities. Chief among these risks are price fluctuations, perish-ability, lack of supply, and lack of demand. Other risks associated with uncertainties arising in the distribution of services would be included in the pricing calculations. Using this ability to assign a price to the risk profile of the agreement allows the issuer to sell or buy the product as a financial instrument. The financial instrument is used as a means of establishing the nature of the distribution agreements.

Another aspect of the realization of the role is insuring the meeting of obligations at execution. A system of insuring the contract guarantees are upheld is required. This can be met by the use of margin accounts, security deposits and other standard legal means. These guarantees are necessary to enable the continued trust among players in the market.

The foregoing discussion details the development of derivative financial products and supporting technology with particular emphasis in the travel industry. Those of skill in the art will appreciate that the technology according the present invention may be applied across other capacity-driven industries such as air cargo, oil pipelines, advertising, and telecommunications and, therefore, is not limited solely to the travel industry.

A derivative product management and distribution process according to the present invention may include the following steps:

First, a standardized unit of distribution is determined. This shall include defining the unit available for purchase, for example, a number of carrier seats, number of seat miles, cargo capacity, or other unit for a particular industry. This definition should include a standard unit of purchase, a standard of quality and any other contractual arrangements necessary to govern the distribution of the unit of purchase. In the air travel industry, this might be 10 seats on all published morning departures from JFK to SFO during the month of June. The definition also specifies the quality of service and reservation rights of the party receiving the capacity. This would cover class of service, refundability, change rights, stay restrictions, upgradability, legibility for loyalty program rewards and any relevant means of differentiating capacity products. It shall also specify distribution arrangements such as reservation and inventory mechanisms required to book a reservation for use of the capacity.

Next, a verifiable financial evaluation for the distribution unit is established. This evaluation would include modeling of a fair value which can be agreed by all parties buying and selling the unit under normal market conditions. This modeling can be achieved using methods commonly employed in financial analysis. In the event of market collapse, it is impractical to use the standard reporting entity price. Typically in this case, the value of closely allied products is used as surrogate markers of value.

Information channels that insure that all future parties buying contracts have access to the high frequency financial data are required to validate the fair value in near real time. Internet communication protocols, high frequency data could be supplied to users accurately, securely and rapidly via file downloading. Client-server architectures typical of high speed data transfer could successfully fulfill these requirements.

The current and desired distribution channel, for example, contractual time period, terms for distribution, and other desired features of the distribution relationship is recorded and analyzed. The industry standards for distribution contracts would need to be elicited from parties desiring to distribute the underlying commodity. These would dictate the set of features, strike price formulation, and terms of the derivative contracts.

Data is collected on unit price dynamics, price volatility, riskless interest rate, and any other influencing factors and informational variables. This could be provided using appropriate internet and database technology. Information channels to appropriate suppliers, distributors, and electronic marketplaces could be used to gather near real time feeds across the internet. Other data busses could be built and used as desired. Files transferred from the data source could be collected, cleansed and stored in a datawarehouse for later retrieval. Computation of volatility statistics, trending, heteroschedasticity, autocorrelation and other factors of interest could be computed from the warehoused data on approporiate servers. The use of standard financial analysis tools, such as Generalized Moment Method, ARCH/GARCH models, simulation and other typical mathematical and statistical methods, could be appropriately employed.

Inventory hedging begins by realizing that the future price is the sum of the current price and value of future price movements. These future price movements are uncertain and represent risk to the holder of inventory. Everyone selling inventory must decide whether to sell now or continue holding, risking immediate profit for the possibility of a better deal to come. Rationally, this decision is based on whether the expected value of future price movements meets expectation. The derivatives price that expected value. This allows a supplier to hedge its inventory successfully. The process builds hedging strategies. Derivatives, tied to the spot market price, provide the means of proportionally and manageably sharing risk between suppliers and distributors. It ties the distributors' interest to the interest of the supplier through risk and profit sharing. Inventory hedging offers the strategic potential, flexibility, and the leverage of financial risk management to answer the challenges of distribution across the electronic supply chain.

The economic benefits of derivatives in the commodity's supply chain are felt by each of us everyday. Derivatives smooth out the effects of uncertain harvests and the fluctuations in jet fuel prices. The expansion of the U.S. agribusiness since 1850 has largely been economically fueled by the growth of future and option markets in agricultural products.

Fuel hedging has become a staple for controlling airline costs. The present invention brings those same benefits to travel product markets. Hedging programs according to the present invention mitigate much of the supplier's risk of entry into an exchange. By stimulating the use of B2B product exchanges, the present invention offers a three-sided value proposition to suppliers, distributors, and exchanges. This contributes to increasing the economic efficiency of the marketplace. Suppliers benefit from the two-way flow of information that is engendered by using an exchange. A standardized, dynamic pricing methodology allows the market to be responsive to public demand and ends the appearance of price collusion. Inventory hedging is a sound business practice that can immediately be reflected in the stock evaluation of the hedger. Distributors can use options to secure inventory, provide fixed procurement costs, and/or speculate on demand. Risk management according to the present invention aid buyers, sellers, speculators, and hedgers utilize the emerging exchanges. This builds transaction volume and market liquidity thus providing a more stable, secure product supply chain.

The present invention improves the statistical use of pricing and demand information via the enriched two-way flow of information in new B2B e-marketplaces.

Leveraging existing legacy systems, the present invention can be integrated into the current workflow of suppliers and distributors with the least impact possible.

These models should include prognosis of future prices, trends, size of price changes, and other factors at play under normal market conditions.

Derivative contract are designed to encapsulate the results of modeling, analysis and lessons learned. These derivative contracts will combine, for example, standard derivative features, such as specification of the underlying unit of purchase, expiration time, strike price formulation, and quality standards, with exotic features to match the characteristics of industry appropriate distribution relations. Example of exotic features, which could be employed, are Asian or average rate features, American features, barrier features, rainbow features and pay later features. By matching these features desired characteristics of the contracts could be created.

A fair price for the designed derivative is developed. A pricing engine to develop the fair price can be built using collected information. The pricing models could, for example, incorporate models of the fair value and trends of the value, estimation of the cost of supplying liquidity, probability of transaction prior to expiration, modeling and estimation of information variables. In addition, if the fair value is tied to a market value, the pricing models require parametric estimation of the autocorrelation of order flow. The pricing engine could be able to supply real time pricing information to all parties involved in the buying and selling of the financial products.

Accounting systems and financial institutions required to guarantee the contracts are honored, and evaluate the financial worth of portfolios can be established. Evaluation can be done with marking-to-model or marking-to-market techniques. Insuring that contracts are honored can be done by either using credit risk estimation or employing a clearinghouse functionality, which backs options, assigns option executions to obligated parties and holds margin accounts.

A mechanism to distribute the derivative products can be built or an existing exchange can be used. The use of over-the-counter investment banking style services or exchange trading can be used to distribute the products. In the first case, accounting and database systems will be required to meet legal accountability standards. Exchange trading techniques would entail the establishment of order processing mechanisms, posting of bid and/or ask prices, and fulfillment mechanisms. Such systems can be supplied online, via appropriate Internet and database technology. The industry environment drives particulars of the fulfillment mechanism. An example of how to structure fulfillment in the airline industry is given later in this description.

Market position can be adjusted through sell and purchase of derivatives products to maximize distribution performance. Standard trading platforms in use through financial markets today could be employed to fulfill the requirements for monitoring and trading. Software/hardware systems designed for financial risk management in the banking and financial services industry could be readily adapted for use in derivative-based distribution.

One of the challenges that arise as new industries move into the creation and trading of financial derivative products is the question of fulfillment, or how to take delivery. The delivery in the instance of the travel industry is the exchange of information, via either a group passenger name record (PNR) and/or passenger name list (PNL), required in block space control. The major GDSs and airline host systems have already answered the fulfillment/delivery question in the travel industry. Their block space record mechanisms make an ideal platform for the treatment of derivative products. Block space booking requests are fulfilled outside the normal GDS inventory system. Thus names for bookings do not have to be supplied until a specified time in the booking process. This allows trading to occur externally of the GDS, without requiring ownership reporting until the derivative expiration date. Therefore, the process for delivery and fulfillment in the option environment is no different than the processes in place today for dealing with negotiated agreement programs. Therefore, the front end or business interaction side of the airline might change, but with the back office functions would remain intact.

Derivatives create a standard contract format to replace the individually negotiated agreements between suppliers and distributors. A suitable pricing engine requires secure Internet infrastructure for collecting pricing, availability, and other data from data sources (e.g. EXCAMBRIA, ITA, SABRE) and distributing information to clients.

The pricing engine, in one embodiment, is a software system capable of pricing the derivative products that are being sold. One such system would be composed of three parts: a historical pricing database, a statistical computation subsystem and a real-time pricing computation subsystem. The database subsystem records industry available pricing and availability data that are critical to the computation of volatility and trends of prices. A statistical software system capable of tracking volatility, trends and price history prepares and analyzes historical data as needed by the pricing computations. Finally a pricing subsystem, running in real-time, computes and posts current prices on derivative products being traded.

One embodiment leverages existing GDS and negotiated program business processes to the greatest extent possible. This creates the least impact on supplier clients and GDSs. Options use industry accepted block space inventory. This means trading can go on unimpeded by the requirements of name change processes, segment changes, segment cancellations nor requires the creation of any special transferable products. It is important to note that options in some embodiments confer the right to book with stated conditions, they are not actual bookings until exercised. At execution, the fulfillment of the required booking is done through a fulfillment engine. The fulfillment engine is simpler than a booking engine, since it need only request a block space booking and transmit a Passenger Name List (PNL) at the appropriate time.

The present invention supports the creation of a data-warehouse for historical demand and pricing information. The statistical use of this warehouse enables traders and analysts to exploit market trends and tendencies with greater speed and ease than other market players.

The following example describes utilization of the systems and methods according to the present invention with a typical airline referred to as AeroDinero (AD). AD is an up and coming Mexican airline. AD specializes in leisure trips from the U.S. to Mexican resort destinations. AD has an active market with package tour operators, dive packages and cruises. AD uses block space agreements for these distribution channels.

AD provides travel between a variety of different airports, generically labeled XYZ and Cancun (Airport Station Code=CAN). This is defined to be physical transportation in an airborne vehicle from the airport XYZ to CAN, on a given date, within legally defined time limits, specified by the AD's published schedule, and international aviation law. This transportation shall include other amenities as needed, such as baggage handling; ticketing; booking a reservation; check-in services; and other standard industry practices. Round trip travel shall be defined as the same basic travel above, except it shall include a return trip from CAN to XYZ within a specified period of time.

In applying the present invention to this example, the following steps will be applied:

1. Analyze Structure of Negotiated Programs

2. Establish Goals for Distribution Channels

3. Define Standardized Option Contract

4. Decide Distribution Method and Implement Trading System

5. Establish the Inventory Hedge

The following sample analysis is made with respect to a particular travel market of relevance to AD, namely the MKE-CUN market. Block Space Agreements on MKE-CUN market have the following features:

Fixed Price $450 RT/Nontransferable ticket/Books as B class

Block Space Seats Expire 14 Days Prior to Departure

Agreements made 1 year in advance of departure

The Pricing History for this market has the following characteristics:

Average Lowest Available Published Fare at 14 days prior is $500

Standard Deviation from Average is $100

The Riskless Interest rate is 5% per annum

AD's distribution channel goals for this market are as follows:

GOAL #1: Combat lost revenue due to heavy spoilage in blocks

GOAL #2: Capture marginal revenue due to large fluctuation in fares at Day 14 Prior to Departure

In the traditional negotiated program, AD would establish a block of seats for example 35 per day at a fixed price (e.g. $450 RT) with a fixed expiration date such as 14 days prior to departure. A derivative product, in this case, a call option contract may be used to achieve AD's goals. Such a derivative product might have the following characteristics:

Option Contract

| | |
|---|---|
| Market: | MKE-CUN |
| Option: | Call |
| Features: | Option invalid if fare reaches $550 |
| Strike Price: | $415 RT |
| Premium: | $24.50 |
| Expiration: | 14 days prior |
| Notes: | Strike Price/Premium calculated from established pricing |
| | formula |
| | Assumes dealer distribution, or no exchange activity |

AD may distribute its derivative products either via its own system where it acts as dealer distributor, selling options directly to consolidators. Alternatively, an exchange environment may be used; such an exchange environment could include pricing engine, decision support and monitoring software installed at AD. This system tracks fares, hedging parameters and market trends.

An Inventory hedging strategy is determined to meet Goals.

To control spoilage: a ratio spread strategy is used, i.e. book fewer seats than options sold

To capture marginal revenue: barrier feature (option is invalid if fare >$550) captures potential upside.

In a traditional negotiated program model, AD would incur CRS charges associated with booking the 35 seats (70 segments). If the CRS charge is $3.50/seat/segment, AD has incurred $245.00 while the purchaser of the block has incurred no charge. Under a derivative product approach, the purchaser incurs costs for the purchased options of the premium (e.g. $24.50)/seat; in this case an expense of $857.50 payable to AD. AD may hedge its allocation and only reserve a block of 17 seats (34 segments), in doing so AD will incur CRS expenses of $119.00. In reaching this point, AD has achieved a net positive of $738.50.

At 14 days prior to departure, the actual seat allocation by the purchaser is known both in the traditional approach and the derivative product approach; assume the purchaser wishes to use 20 seats out of the 35 block. In the traditional approach, the purchaser would pay AD $9000.00 (negotiated price ($450) * number of seats (20)). In the derivative product approach, the purchaser exercises 20 of the options. AD allocates an additional 3 seats (6 segments) incurring an additional CRS fee of $21.00. The purchaser pays AD $8300.00 (price under option ($415) * number of seats (20)). AD nets $8279.00. It should also be noted that the traditional approach does not take into account the spoilage risk of the 15 seats returned to AD by the purchaser nor the additional CRS fees associated with cancellation/rebooks.

Examining the totals overall, under the traditional approach the purchaser pays $9000.00 of which AD receives $8755.00 after the $245.00 in CRS fees. Under the derivative product approach, the purchaser pays $9157.50 ($8300 ticket cost plus 875.50 option cost) of which AD receives $9017.50 after the $140.00 in CRS fees.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of trading an airline fare product, comprising:
providing a derivative product wherein the derivative product is based on a forward contract for the purchase of at least one airline fare product; and
at least one of selling, trading, and executing the derivative product.

2. The method of trading an airline fare product of claim 1, wherein the derivative product is a call option.

3. The method of trading an airline fare product of claim 1, wherein the derivative product is a put option.

4. The method of trading an airline fare product of claim 1, wherein the derivative product is a forward.

5. The method of trading an airline fare product of claim 1, wherein the derivative product is a future.

6. The method of trading an airline fare product of claim 1, wherein the derivative product is a swap.

7. The method of trading an airline fare product of claim 1, wherein the derivative product is a swaption.

8. The method of trading an airline fare product of claim 1, wherein the derivative product is a strategy composed of a combination of call options, put options, forwards, futures, swaps, and/or swaptions.

9. The method of trading an airline fare product of claim 1, wherein the derivative product is based on at least one of a fixed airline fare, availability of the airline fare product, a commission associated with the sale of the airline fare product, a volume discount of the airline fare product, a purchasing time limit for the airline fare product, and inventory of the airline fare product.

10. The method of trading an airline fare product of claim 1, wherein the derivative product is based on at least one of a hard block interline code-sharing marketing agreement, a soft block code interline code-sharing marketing agreement, a sell and report interline code-sharing marketing agreement, and an Available Seat Mile (ASM) buy interline code-sharing marketing agreement

11. The method of trading an airline fare product of claim 1, wherein the forward contract is a commission agreement.

12. The method of trading an airline fare product of claim 1, wherein the forward contract is a net fare agreement.

13. The method of trading an airline fare product of claim 1, wherein the forward contract is a block space agreement.

14. The method of trading an airline fare product of claim 1, wherein the forward contract is a hard block interline code-share agreement.

15. The method of trading an airline fare product of claim 1, wherein the forward contract is a soft block interline code-share agreement.

16. The method of trading an airline fare product of claim 1, wherein the forward contract is a sell and report interline code-share agreement.

17. The method of trading an airline fare product of claim 1, wherein the forward contract is an Available Seat Mile (ASM) buy interline code-share agreement.

18. A method of trading derivative products related to airline fare products, comprising:
transforming negotiated airline fare agreements between parties comprising suppliers and distributors into derivative products;
monetize the embedded forwards and options with the distribution of airline fare products; and
at least one of selling, trading, and executing the derivative products.

19. The method according to claim 18, wherein transforming includes:
determining a standardized unit of distribution for the capacity driven industry; and
defining a unit available for purchase in the derivative product.

20. The method according to claim 19, wherein defining includes:
defining contractual arrangements which govern the distribution of the unit available for purchase; and
defining distribution arrangements required to generate a reservation for use of the unit available for purchase.

21. The method according to claim 19, wherein transforming includes establishing a verifiable financial evaluation of a fair market value for the unit available for purchase.

22. The method according to claim 21, further comprising:
designing derivative contracts based on the verifiable financial evaluation for the unit available for purchase.

23. The method according to claim 22, wherein the derivative contracts comprise specifications for the unit available for purchase, time of expiration, strike price formulation, and quality standards, and further comprise exotic features to match characteristics of industry specific distribution relationships.

24. The method according to claim 22, wherein the derivative contracts comprise specifications for the unit available for purchase and further comprise exotic features to match characteristics of industry specific distribution relationships.

25. The method according to claim 18, wherein transforming includes providing information channels to insure all future parties buying and selling the derivative products have access to financial data required to validate fair market value of the derivative products in substantially in real time.

26. The method according to claim 18, wherein transforming includes collecting data on influencing factors and informational variables for the derivative products.

27. The method according to claim 26, further comprising:
determining a price for the derivative product using a pricing engine.

28. The method according to claim 27, wherein the pricing engine includes pricing models which incorporate at least one of a model of fair market value and trends thereof, an estimation of cost of supplying liquidity, and a probability of transaction prior to expiration of contracts.

29. The method according to claim 28, wherein said pricing engine includes a software system capable of pricing the derivative product, the pricing engine further comprising:
a historical pricing database which records pricing and availability data used to compute price volatility and trends of the derivative product;
a statistical computation subsystem which tracks price volatility, trends, and price history of the derivative product and prepares historical data for use in pricing computation; and
a real time pricing computation subsystem which computes and posts current prices of derivative products being traded.

30. The method according to claim 29, wherein said pricing engine includes a software system capable of pricing the derivative product, the pricing engine further comprising:
a historical pricing database which records pricing and availability data used to compute price volatility and trends of the derivative product;
a statistical computation subsystem which tracks price volatility, trends, and price history of the derivative product and analyzes historical data for use in pricing computation; and
a real time pricing computation subsystem which computes and posts current prices of derivative products being traded.

31. The method according to claim 19, wherein transforming includes:
building a forecast model for the unit for purchase's financial worth; and
determining an amount of volatility of the forecast model over a predetermined period of time.

32. The method according to claim 18, wherein transforming includes:
establishing accounting systems and financial institutions to guarantee the derivative products are honored and to evaluate a financial worth of portfolios.

33. The method according to claim 32, wherein the evaluation includes using one of marking-to-model and marking-to-market techniques.

34. The method according to claim 32, wherein the guaranteeing includes one of using credit risk estimation and employing a clearinghouse functionality, backing options, assigning option executions to obligated parties, and holding margin accounts.

35. The method according to claim 18, wherein transforming includes providing a mechanism to distribute the derivative products.

36. The method according to claim 35, wherein the mechanism includes one of over-the-counter investment style banking services and exchange trading.

37. The method according to claim 18, wherein the derivative products include option contracts and wherein the negotiated agreements between said parties are transformed into an option contract by an investment services provider.

38. The method according to claim 37, wherein the investment service provider issues said option contract, takes the opposite side of the issued contract, guarantees the contract, and sells complimentary agreements to distributors in a business-to-business marketplace.

39. The method according to claim 37, wherein the supplier in said capacity driven industry uses said investment services provider to broker a derivatives-based distribution agreement between said supplier and said distributor.

40. The method according to claim 39, wherein the derivatives-based distribution agreement comprises a network of rights, the network of rights comprises:
an ability to reserve a service of a specified quality, at a specified time;
a guarantee of availability,
pricing agreements,
commissions and discounts,
reservation time limits,
distribution rights, and
bundling rights.

41. A method of trading derivative products related to airline fare products, comprising:
transforming interline code-sharing agreements between parties comprising a supplying air carrier and marketing air carrier into derivative products;
monetize the embedded forwards and options with the distribution of airline fare products; and
at least one of selling, trading, and executing the derivative products.

42. The method according to claim 41, wherein transforming includes:
determining a standardized unit of distribution for the capacity driven industry; and
defining a unit available for purchase in the derivative product.

43. The method according to claim 42, wherein defining includes:
defining contractual arrangements which govern the distribution of the unit available for purchase; and
defining distribution arrangements required to generate a reservation for use of the unit available for purchase.

44. The method according to claim 42, wherein transforming includes establishing a verifiable financial evaluation of a fair market value for the unit available for purchase.

45. The method according to claim 44, further comprising:
designing derivative contracts based on the verifiable financial evaluation for the unit available for purchase.

46. The method according to claim 45, wherein the derivative contracts comprise specifications for the unit available for purchase, time of expiration, strike price formulation, and quality standards, and further comprise exotic features to match characteristics of industry specific distribution relationships.

47. The method according to claim 45, wherein the derivative contracts comprise specifications for the unit available for purchase and further comprise exotic features to match characteristics of industry specific distribution relationships.

48. The method according to claim 41, wherein transforming includes providing information channels to insure all future parties buying and selling the derivative products have access to financial data required to validate fair market value of the derivative products in substantially in real time.

49. The method according to claim 41, wherein transforming includes collecting data on influencing factors and informational variables for the derivative products.

50. The method according to claim 49, further comprising:
determining a price for the derivative product using a pricing engine.

51. The method according to claim 50, wherein the pricing engine includes pricing models which incorporate at least one of a model of fair market value and trends thereof, an estimation of cost of supplying liquidity, and a probability of transaction prior to expiration of contracts.

52. The method according to claim 51, wherein said pricing engine includes a software system capable of pricing the derivative product, the pricing engine further comprising:
a historical pricing database which records pricing and availability data used to compute price volatility and trends of the derivative product;
a statistical computation subsystem which tracks price volatility, trends, and price history of the derivative product and prepares historical data for use in pricing computation; and
a real time pricing computation subsystem which computes and posts current prices of derivative products being traded.

53. The method according to claim 52, wherein said pricing engine includes a software system capable of pricing the derivative product, the pricing engine further comprising:
a historical pricing database which records pricing and availability data used to compute price volatility and trends of the derivative product;
a statistical computation subsystem which tracks price volatility, trends, and price history of the derivative product and analyzes historical data for use in pricing computation; and
a real time pricing computation subsystem which computes and posts current prices of derivative products being traded.

54. The method according to claim 42, wherein transforming includes:
building a forecast model for the unit for purchase's financial worth; and
determining an amount of volatility of the forecast model over a predetermined period of time.

55. The method according to claim 41, wherein transforming includes:
establishing accounting systems and financial institutions to guarantee the derivative products are honored and to evaluate a financial worth of portfolios.

56. The method according to claim 55, wherein the evaluation includes one of using marking-to-model and marking-to-market techniques.

57. The method according to claim 55, wherein the guaranteeing includes one of using credit risk estimation and employing a clearinghouse functionality, backing options, assigning option executions to obligated parties, and holding margin accounts.

58. The method according to claim 41, wherein transforming includes providing a mechanism to distribute the derivative products.

59. The method according to claim 58, wherein the mechanism includes one of over-the-counter investment style banking services and exchange trading.

60. The method according to claim 41, wherein the derivative products include option contracts and wherein the negotiated agreements between said parties are transformed into an option contract by an investment services provider.

61. The method according to claim 60, wherein the investment service provider issues said option contract, takes the opposite side of the issued contract, guarantees the contract, and sells complimentary agreements to distributors in a business-to-business marketplace.

62. The method according to claim 60, wherein the supplier in said capacity driven industry uses said investment services provider to broker a derivatives-based distribution agreement between said supplier and said distributor.

63. The method according to claim 62, wherein the derivatives-based distribution agreement comprises a network of rights, the network of rights comprises:
an ability to reserve a service of a specified quality, at a specified time;
a guarantee of availability,
pricing agreements,
commissions and discounts,
reservation time limits,
distribution rights, and
bundling rights.
